(19) United States
(12) Patent Application Publication
(10) Pub. No.: US 2022/0055772 A1
(43) Pub. Date: Feb. 24, 2022

(54) METHODS FOR CLEANING AEROSPACE COMPONENTS

(71) Applicant: Applied Materials, Inc., Santa Clara, CA (US)

(72) Inventors: Sukti CHATTERJEE, San Jose, CA (US); Lance A. SCUDDER, Sunnyvale, CA (US); Yuriy MELNIK, San Jose, CA (US); Kenichi OHNO, Sunnyvale, CA (US); Eric H. LIU, Los Altos, CA (US); David Alexander BRITZ, Los Gatos, CA (US)

(21) Appl. No.: 17/404,823

(22) Filed: Aug. 17, 2021

Related U.S. Application Data
(60) Provisional application No. 63/067,116, filed on Aug. 18, 2020.

(51) Int. Cl. B64F 5/30; B08B 7/00

(52) U.S. Cl. CPC B64F 5/30; B08B 7/0071

(57) ABSTRACT

Embodiments of the present disclosure generally relate to methods for cleaning aerospace components having oxidation, corrosion, contaminants, and/or other degradations. In one or more embodiments, a cleaning method includes positioning the aerospace component into a processing region of a processing chamber, introducing hydrogen gas into the processing region, maintaining the processing region at a pressure of about 100 mTorr to about 5,000 mTorr, and heating the aerospace component at a temperature of about 500° C. to about 1,200° C. for about 0.5 hours to about 24 hours to produce a cleaned surface on the aerospace component. In other embodiments, a cleaning method includes exposing the aerospace component to ozone while maintaining the aerospace component at a temperature of about 15° C. to about 500° C. for 0.25 hours to about 24 hours to produce a cleaned surface on the aerospace component.

### CROSS-REFERENCE TO RELATED APPLICATIONS

This application claims benefit to U.S. Prov. Appl. No. 63/067,116, filed on Aug. 18, 2020, which is herein incorporated by reference.

### BACKGROUND

### Field

Embodiments of the present disclosure generally relate to cleaning processes, and in particular to cleaning processes for aerospace components.

### Description of the Related Art

Aerospace components, such as turbine engines, typically have parts or components which oxidize, corrode, or otherwise degrade over time due to being exposed to pollution, hot gases, and/or other reactive chemicals (e.g., acids, bases, or salts). Aerospace components are often protected by a thermal and/or chemical barrier, such as a protective coating. The current coatings used on airfoils exposed to the hot gases of combustion in gas turbine engines for both environmental protection and as bond coats in thermal barrier coating (TBC) systems. These protective coatings are applied over substrate materials, typically nickel-based superalloys, to provide protection against oxidation and corrosion attack. However, even with these protective coatings, many aerospace components fail long before the predicted service interval (e.g., about 20,000 hours) due to oxidation, corrosion, contaminants, and/or degradation.

Cleaning processes that use aqueous solutions, acidic solutions, basic solutions, surfactant solutions, and/or organic solvents have been used to clean surfaces of aerospace components. However, cleaning processes which utilize liquid solutions and solvents can further oxidize, corrode, increase carbon concentration, and/or cause undesired effects to the surfaces of the nickel superalloy and/or the protective coating.

Therefore, there is a need for improved methods for cleaning aerospace components.

### SUMMARY

Embodiments of the present disclosure generally relate to cleaning methods for aerospace components. Oxidation, corrosion, and/or one or more other contaminants can be removed from the aerospace component to produce a cleaned surface by the cleaning methods described and discussed herein. The contaminant can be on the surface of a superalloy substrate or component, as well as on a protective coating disposed on the underlying superalloy substrate or component.

In one or more embodiments, a method for cleaning an aerospace component includes exposing the aerospace component to hydrogen gas (H₂) while heating the aerospace component to produce a cleaned surface on the aerospace component. For example, the cleaning method can include positioning the aerospace component into a processing region of a processing chamber, introducing hydrogen gas into the processing region, maintaining the processing region at a pressure of about 100 mTorr to about 5,000 mTorr, and heating the aerospace component at a temperature of about 500° C. to about 1,200° C. for about 0.5 hours to about 24 hours to remove the contaminant and produce a cleaned surface on the aerospace component.

In other embodiments, a method for cleaning an aerospace component includes exposing the aerospace component to ozone to produce a cleaned surface on the aerospace component. For example, the cleaning method can include positioning the aerospace component into a processing region of a processing chamber, introducing ozone into the processing region, maintaining the processing region at atmospheric pressure, such as at a pressure of about 700 Torr to about 800 Torr, and maintaining the aerospace component at a temperature of about 15° C. to about 500° C. for 0.25 hours to about 24 hours to remove the contaminant and produce a cleaned surface on the aerospace component.

### DETAILED DESCRIPTION

Embodiments of the present disclosure generally relate to cleaning methods for aerospace components. The cleaning methods use either hydrogen gas (H₂) or ozone to remove oxidation, corrosion, and/or one or more other contaminants from the aerospace component to produce cleaned surfaces. The aerospace component can be a turbine blade, a turbine blade root, a turbine disk, and/or other components or parts as further described and discussed herein. The underlying substrate or surface of the aerospace component can be or include a superalloy or nickel superalloy which contains nickel, stainless steel, cobalt, chromium, molybdenum, iron, titanium, alloys thereof, or any combination thereof.

One or more protective coatings can be disposed on the superalloy or underlying surface or substrate. The protective coating can include one or more films or layers of the same material of different materials. Each film or layer can be or include one or more aluminides, aluminum oxide, aluminum nitride, aluminum oxynitride, chromium oxide, hafnium oxide, tantalum oxide, tantalum nitride, tantalum oxynitride, silicon oxide, silicon nitride, silicon oxynitride, alloys thereof, or combinations thereof. In some examples, the protective coatings can be or include monolayer films, multi-layer films, nanolaminate film stacks, coalesced films, crystalline films, or any combination thereof. The protective coating reduces or suppresses oxidation, corrosion, and/or degradation of the underlying superalloy. The protective coatings are also anti-coking coatings to reduce or suppress coke formation when the aerospace component is heated in the presence of a fuel. The protective coatings can be deposited or otherwise formed on interior surfaces and/or exterior surfaces of the aerospace components.

The aerospace component is exposed to one or more cleaning processes to remove one or more contaminants. The contaminants are removed from the aerospace component to produce the cleaned surface during the cleaning process. The contaminant can be or include oxides, corrosion, salts, organics or organic residues, carbon, oil, soil, particulates, debris, and/or other contaminants, or any combination thereof.

In one or more embodiments, methods for cleaning an aerospace component include exposing the aerospace component to hydrogen gas (H₂) while heating the aerospace component to produce a cleaned surface on the aerospace component. In one or more examples, the cleaning method can include positioning the aerospace component into a processing region of a processing chamber, introducing hydrogen gas into the processing region, and exposing the contaminants (e.g., oxidation and/or corrosion) and the aerospace component to the hydrogen gas during the cleaning process. The processing region can be maintained at a pressure of about 100 mTorr to about 5,000 mTorr, while the aerospace component is heated or maintained at a temperature of about 500° C. to about 1,200° C. for about 0.5 hours to about 24 hours to form or otherwise produce a cleaned surface previously occupied by the contaminants on the aerospace component. In some examples, the cleaned surface of the aerospace component is an interior surface within a cavity of the aerospace component, and the cavity can have an aspect ratio of about 5 to about 1,000.

In some embodiments, the processing chamber can be a tube furnace, thermal annealing chamber, or other processing chamber during the cleaning process using hydrogen gas. The processing region can be within the processing chamber or within the cavity of the aerospace component. The processing region is maintained at a pressure of about 100 mTorr, about 150 mTorr, about 200 mTorr, about 250 mTorr, about 300 mTorr, about 400 mTorr, about 500 mTorr, or about 800 mTorr to about 1,000 mTorr, about 1,500 mTorr, about 2,000 mTorr, about 2,500 mTorr, about 3,000 mTorr, about 4,000 mTorr, about 5,000 mTorr, about 7,500 mTorr, or about 10,000 mTorr during the cleaning process using hydrogen gas. For example, the processing region is maintained at a pressure of about 100 mTorr to about 10,000 mTorr, about 100 mTorr to about 5,000 mTorr, about 100 mTorr to about 3,000 mTorr, about 100 mTorr to about 2,000 mTorr, about 100 mTorr to about 1,800 mTorr, about 100 mTorr to about 1,500 mTorr, about 100 mTorr to about 1,200 mTorr, about 100 mTorr to about 1,000 mTorr, about 100 mTorr to about 800 mTorr, about 100 mTorr to about 500 mTorr, about 100 mTorr to about 300 mTorr, about 500 mTorr to about 5,000 mTorr, about 500 mTorr to about 3,000 mTorr, about 500 mTorr to about 2,000 mTorr, about 500 mTorr to about 1,500 mTorr, about 500 mTorr to about 1,200 mTorr, about 500 mTorr to about 1,000 mTorr, about 500 mTorr to about 800 mTorr, about 700 mTorr to about 5,000 mTorr, about 700 mTorr to about 3,000 mTorr, about 700 mTorr to about 2,000 mTorr, about 700 mTorr to about 1,500 mTorr, about 700 mTorr to about 1,200 mTorr, about 700 mTorr to about 1,000 mTorr, or about 800 mTorr to about 1,200 mTorr during the cleaning process using hydrogen gas.

The aerospace component is heated or maintained at a temperature of about 400° C., about 500° C., about 600° C., about 700° C., about 750° C., about 800° C., or about 850° C. to about 900° C., about 950° C., about 1,000° C., about 1,050° C., about 1,100° C., about 1,150° C., about 1,200° C., or about 1,300° C. during the cleaning process using hydrogen gas. For example, the aerospace component is heated or maintained at a temperature of about 500° C. to about 1,200° C., about 500° C. to about 1,100° C., about 500° C. to about 1,050° C., about 500° C. to about 1,000° C., about 500° C. to about 950° C., about 500° C. to about 900° C., about 500° C. to about 800° C., about 500° C. to about 700° C., about 700° C. to about 1,200° C., about 700° C. to about 1,100° C., about 700° C. to about 1,050° C., about 700° C. to about 1,000° C., about 700° C. to about 950° C., about 700° C. to about 900° C., about 700° C. to about 800° C., about 700° C. to about 750° C., about 800° C. to about 1,200° C., about 800° C. to about 1,100° C., about 800° C. to about 1,050° C., about 800° C. to about 1,000° C., about 800° C. to about 950° C., about 800° C. to about 900° C., or about 800° C. to about 850° C. during the cleaning process using hydrogen gas.

The aerospace component is exposed to hydrogen gas and heated for a predetermined time during the cleaning process. The cleaning process using hydrogen gas is conducted for about 0.5 hours (hr), about 0.8 hr, about 1 hr, about 1.5 hr, about 2 hr, about 3 hr, about 5 hr, or about 7 hr to about 8 hr, about 10 hr, about 12 hr, about 15 hr, about 18 hr, about 20 hr, about 24 hr, or longer. For example, the cleaning process using hydrogen gas is conducted for about 0.5 hr to about 24 hr, about 1 hr to about 24 hr, about 2 hr to about 24 hr, about 3 hr to about 24 hr, about 4 hr to about 24 hr, about 5 hr to about 24 hr, about 8 hr to about 24 hr, about 10 hr to about 24 hr, about 12 hr to about 24 hr, about 15 hr to about 24 hr, about 0.5 hr to about 12 hr, about 1 hr to about 12 hr, about 2 hr to about 12 hr, about 3 hr to about 12 hr, about 4 hr to about 12 hr, about 5 hr to about 12 hr, about 8 hr to about 12 hr, about 0.5 hr to about 6 hr, about 1 hr to about 6 hr, about 2 hr to about 6 hr, about 3 hr to about 6 hr, or about 4 hr to about 6 hr.

In one or more examples, the aerospace component is heated or maintained at a temperature of about 500° C. to about 1,200° C. for about 0.5 hr to about 24 hr during the cleaning process using hydrogen gas. In other examples, the aerospace component is heated or maintained at a temperature of about 700° C. to about 1,100° C. for 1 hr to about 18 hr during the cleaning process using hydrogen gas. In some examples, the aerospace component is heated or maintained at a temperature of about 800° C. to about 1,000° C. for 2 hr to about 8 hr during the cleaning process using hydrogen gas.

The hydrogen gas is introduced into the processing region and/or exposed to the aerospace component at a flow rate of about 50 sccm, about 100 sccm, about 250 sccm, about 500 sccm, about 750 sccm, about 900 sccm, or about 1,000 sccm to about 1,200 sccm, about 1,500 sccm, about 1,800 sccm, about 2,000 sccm, about 2,500 sccm, about 3,000 sccm, about 4,000 sccm, about 5,000 sccm, or greater. For example, the hydrogen gas is introduced into the processing region and/or exposed to the aerospace component at a flow rate of about 50 sccm to about 5,000 sccm, about 100 sccm to about 5,000 sccm, about 300 sccm to about 5,000 sccm, about 500 sccm to about 5,000 sccm, about 800 sccm to about 5,000 sccm, about 1,000 sccm to about 5,000 sccm, about 1,500 sccm to about 5,000 sccm, about 2,000 sccm to about 5,000 sccm, about 3,000 sccm to about 5,000 sccm, about 100 sccm to about 3,000 sccm, about 50 sccm to about 2,000 sccm, about 100 sccm to about 2,000 sccm, about 300 sccm to about 2,000 sccm, about 500 sccm to about 2,000 sccm, about 800 sccm to about 2,000 sccm, about 1,000 sccm to about 2,000 sccm, about 1,500 sccm to about 2,000 sccm, about 2,000 sccm to about 2,000 sccm, about 3,000 sccm to about 2,000 sccm, about 50 sccm to about 1,000 sccm, about 100 sccm to about 1,000 sccm, about 300 sccm to about 1,000 sccm, about 500 sccm to about 1,000 sccm, or about 800 sccm to about 1,000 sccm.

In other embodiments, methods for cleaning an aerospace component include exposing the aerospace component to ozone to produce a cleaned surface on the aerospace component. In one or more examples, the cleaning method can include positioning the aerospace component into a processing region of a processing chamber, introducing ozone into the processing region, and exposing the contaminants (e.g., oxidation and/or corrosion) and the aerospace component to the ozone during the cleaning process. The processing region can be maintained at atmospheric or ambient pressure (e.g., about 760 Torr), or at a pressure of up to 1,100 Torr or 1,000 Torr, such as about 500 Torr to about 1,000 Torr or about 700 Torr to about 800 Torr, while the aerospace component is heated or maintained at a temperature of about 15° C. to about 500° C. for 0.25 hours to about 24 hours to form or otherwise produce a cleaned surface previously occupied by the contaminants on the aerospace component. In some examples, the cleaned surface of the aerospace component is an interior surface within a cavity of the aerospace component, and the cavity can have an aspect ratio of about 5 to about 1,000.

During the cleaning process using ozone, the processing chamber can be a process furnace, thermal annealing chamber, or other processing chamber. The processing region can be within the processing chamber or within the cavity of the aerospace component. The processing region is maintained at a pressure of about 500 Torr, about 550 Torr, about 600 Torr, about 650 Torr, about 700 Torr or about 750 Torr to about 760 Torr, about 780 Torr, about 800 Torr, about 850 Torr, about 900 Torr, or about 1,000 Torr during the cleaning process using ozone. For example, the processing region is maintained at a pressure of about 500 Torr to about 1,000 Torr, about 600 Torr to about 1,000 Torr, about 700 Torr to about 1,000 Torr, about 750 Torr to about 1,000 Torr, about 760 Torr to about 1,000 Torr, about 780 Torr to about 1,000 Torr, about 800 Torr to about 1,000 Torr, about 850 Torr to about 1,000 Torr, about 500 Torr to about 800 Torr, about 600 Torr to about 800 Torr, about 700 Torr to about 800 Torr, about 750 Torr to about 800 Torr, about 760 Torr to about 800 Torr, about 780 Torr to about 800 Torr, about 500 Torr to about 780 Torr, about 600 Torr to about 780 Torr, about 700 Torr to about 780 Torr, about 750 Torr to about 780 Torr, or about 760 Torr to about 780 Torr during the cleaning process using ozone.

The aerospace component is heated or maintained at a temperature of about 0° C., about 10° C., about 15° C., about 20° C., about 22° C., about 25° C., about 30° C., about 40° C., about 50° C., about 80° C., about 100° C., about 150° C., about 200° C., about 230° C., or about 250° C. to about 280° C., about 300° C., about 320° C., about 350° C., about 380° C., about 400° C., about 450° C., about 500° C. during the cleaning process using ozone. For example, the aerospace component is heated or maintained at a temperature of about 0° C. to about 500° C., about 0° C. to about 400° C., about 15° C. to about 400° C., about 22° C. to about 400° C., about 25° C. to about 400° C., about 30° C. to about 400° C., about 50° C. to about 400° C., about 100° C. to about 400° C., about 100° C. to about 450° C., about 150° C. to about 400° C., about 200° C. to about 400° C., about 250° C. to about 400° C., about 280° C. to about 400° C., about 300° C. to about 400° C., about 320° C. to about 400° C., about 350° C. to about 400° C., about 0° C. to about 350° C., about 15° C. to about 350° C., about 22° C. to about 350° C., about 25° C. to about 350° C., about 30° C. to about 350° C., about 50° C. to about 350° C., about 100° C. to about 350° C., about 150° C. to about 350° C., about 200° C. to about 350° C., about 250° C. to about 350° C., about 280° C. to about 350° C., about 300° C. to about 350° C., about 320° C. to about 350° C., about 0° C. to about 300° C., about 15° C. to about 300° C., about 22° C. to about 300° C., about 25° C. to about 300° C., about 30° C. to about 300° C., about 50° C. to about 300° C., about 100° C. to about 300° C., about 150° C. to about 300° C., about 200° C. to about 300° C., about 250° C. to about 300° C., or about 280° C. to about 300° C. during the cleaning process using ozone. In one or more examples, the aerospace component is at room or ambient temperature, which can be from about 15° C. to about 30° C., such as about 20° C. to about 25° C., during the cleaning process using ozone.

The aerospace component is exposed to ozone and heated for a predetermined time during the cleaning process. The cleaning process using hydrogen gas is conducted for about 0.5 hr, about 0.8 hr, about 1 hr, about 1.5 hr, about 2 hr, about 3 hr, about 5 hr, or about 7 hr to about 8 hr, about 10 hr, about 12 hr, about 15 hr, about 18 hr, about 20 hr, about 24 hr, or longer. For example, the cleaning process using ozone is conducted for about 0.5 hr to about 24 hr, about 1 hr to about 24 hr, about 2 hr to about 24 hr, about 3 hr to about 24 hr, about 4 hr to about 24 hr, about 5 hr to about 24 hr, about 8 hr to about 24 hr, about 10 hr to about 24 hr, about 12 hr to about 24 hr, about 15 hr to about 24 hr, about 0.5 hr to about 12 hr, about 1 hr to about 12 hr, about 2 hr to about 12 hr, about 3 hr to about 12 hr, about 4 hr to about 12 hr, about 5 hr to about 12 hr, about 8 hr to about 12 hr, about 0.5 hr to about 6 hr, about 1 hr to about 6 hr, about 2 hr to about 6 hr, about 3 hr to about 6 hr, or about 4 hr to about 6 hr.

In one or more examples, the aerospace component is heated or maintained at a temperature of about 15° C. to about 500° C. for 0.25 hr to about 24 hr during the cleaning process using ozone. In other examples, the aerospace component is heated or maintained at a temperature of about 100° C. to about 450° C. for 1 hr to about 18 hr during the cleaning process using ozone. In some examples, the aerospace component is heated or maintained at a temperature of about 200° C. to about 400° C. for about 0.5 hr to about 5 hr during the cleaning process using ozone. In other examples, the aerospace component is heated or maintained at a temperature of about 250° C. to about 350° C. for 0.8 hr to about 2 hr during the cleaning process using ozone.

The ozone is introduced into the processing region and/or exposed to the aerospace component at a flow rate of about 50 sccm, about 100 sccm, about 250 sccm, about 500 sccm, about 750 sccm, about 900 sccm, or about 1,000 sccm to about 1,200 sccm, about 1,500 sccm, about 1,800 sccm, about 2,000 sccm, about 2,500 sccm, about 3,000 sccm, about 4,000 sccm, about 5,000 sccm, or greater. For example, the ozone is introduced into the processing region and/or exposed to the aerospace component at a flow rate of about 50 sccm to about 5,000 sccm, about 100 sccm to about 5,000 sccm, about 300 sccm to about 5,000 sccm, about 500 sccm to about 5,000 sccm, about 800 sccm to about 5,000 sccm, about 1,000 sccm to about 5,000 sccm, about 1,500 sccm to about 5,000 sccm, about 2,000 sccm to about 5,000 sccm, about 3,000 sccm to about 5,000 sccm, about 100 sccm to about 3,000 sccm, about 50 sccm to about 2,000 sccm, about 100 sccm to about 2,000 sccm, about 300 sccm to about 2,000 sccm, about 500 sccm to about 2,000 sccm, about 800 sccm to about 2,000 sccm, about 1,000 sccm to about 2,000 sccm, about 1,500 sccm to about 2,000 sccm, about 2,000 sccm to about 2,000 sccm, about 3,000 sccm to about 2,000 sccm, about 50 sccm to about 1,000 sccm, about 100 sccm to about 1,000 sccm, about 300 sccm to about 1,000 sccm, about 500 sccm to about 1,000 sccm, or about 800 sccm to about 1,000 sccm.

Aerospace components as described and discussed herein can be or include one or more components, parts, or portions thereof of a turbine, an aircraft, a spacecraft, a windmill, a ground-based power generation system, or other devices that can include one or more turbines (e.g., generators, compressors, pumps, turbo fans, super chargers, and the like). Exemplary aerospace components and superalloy substrates can be or include a turbine blade, a turbine blade root (e.g., fir tree or dovetail), a turbine disk, a turbine vane, a support member, a frame, a rib, a fin, a pin fin, a fuel nozzle, a combustor liner, a combustor shield, a heat exchanger, a fuel line, a fuel valve, an internal cooling channel, any combination thereof, or any other aerospace component or part that can benefit from the cleaning methods described and discussed herein. The aerospace component typically has a thickness of about 1 mm, about 1.5 mm, or about 2 mm to about 3 mm, about 5 mm, about 8 mm, or about 10 mm. For example, the aerospace component can have a thickness of about 1 mm to about 5 mm or about 2 mm to about 3 mm.

The aerospace component has one or more outer or exterior surfaces and one or more inner or interior surfaces. The protective coating can be deposited or otherwise formed on interior surfaces and/or exterior surfaces of the aerospace components. The interior surfaces can define one or more cavities extending or contained within the aerospace component. The cavities can be channels, passages, spaces, or the like disposed between the interior surfaces. The cavity can have one or more openings. Each of the cavities within the aerospace component typically have aspect ratios (e.g., length divided by width) of greater than 1. The methods described and discussed herein provide depositing and/or otherwise forming the protective coating on the interior surfaces with high aspect ratios (greater than 1) and/or within the cavities.

The aspect ratio of the cavity can be from about 2, about 3, about 5, about 8, about 10, or about 12 to about 15, about 20, about 25, about 30, about 40, about 50, about 65, about 80, about 100, about 120, about 150, about 200, about 250, about 300, about 500, about 800, about 1,000, or greater. For example, the aspect ratio of the cavity can be from about 2 to about 1,000, about 2 to about 500, about 2 to about 200, about 2 to about 150, about 2 to about 120, about 2 to about 100, about 2 to about 80, about 2 to about 50, about 2 to about 40, about 2 to about 30, about 2 to about 20, about 2 to about 10, about 2 to about 8, about 5 to about 1,000, about 5 to about 500, about 5 to about 200, about 5 to about 150, about 5 to about 120, about 5 to about 100, about 5 to about 80, about 5 to about 50, about 5 to about 40, about 5 to about 30, about 5 to about 20, about 5 to about 10, about 5 to about 8, about 10 to about 1,000, about 10 to about 500, about 10 to about 200, about 10 to about 150, about 10 to about 120, about 10 to about 100, about 10 to about 80, about 10 to about 50, about 10 to about 40, about 10 to about 30, about 10 to about 20, about 20 to about 1,000, about 20 to about 500, about 20 to about 200, about 20 to about 150, about 20 to about 120, about 20 to about 100, about 20 to about 80, about 20 to about 50, about 20 to about 40, or about 20 to about 30.

The aerospace component and any surface thereof including one or more outer or exterior surfaces and/or one or more inner or interior surfaces can be made of, contain, or otherwise include one or more metals, such as nickel, chromium, cobalt, chromium-cobalt alloys, molybdenum, iron, titanium, one or more nickel superalloys, one or more Inconel alloys, one or more Hastelloy alloys, one or more Invar alloys, one or more Inovoco alloys, alloys thereof, or any combination thereof. The protective coating can be deposited, formed, or otherwise produced on any surface of the aerospace component including one or more outer or exterior surfaces and/or one or more inner or interior surfaces.

The protective coating, as described and discussed herein, can be or include one or more of laminate film stacks, coalesced films, crystalline film, graded compositions, and/or monolithic films which are deposited or otherwise formed on any surface of an aerospace component. In some examples, the protective coating contains from about 1% to about 100% chromium oxide. The protective coating is conformal and substantially coat rough surface features following surface topology, including in open pores, blind holes, and non-line-of sight regions of a surface. The protective coating does not substantially increase surface roughness, and in some embodiments, the protective coating may reduce surface roughness by conformally coating roughness until it coalesces. The protective coating may contain particles from the deposition that are substantially larger than the roughness of the aerospace component, but are considered separate from the monolithic film. The protective coating is substantially well adhered and pinhole free. The thicknesses of the protective coating can vary within 1-sigma of 40%. In one or more embodiments, the thickness varies less than 1-sigma of 20%, 10%, 5%, 1%, or 0.1%.

In one or more embodiments, the protective coating can include one or more films or layers of the same material of different materials. Each film or layer can independently be or include one or more aluminides, aluminum oxide, aluminum nitride, aluminum oxynitride, chromium oxide, tantalum oxide, tantalum nitride, tantalum oxynitride, yttrium oxide, yttrium nitride, yttrium silicon nitride, hafnium oxide, hafnium nitride, hafnium silicide, hafnium silicate, titanium oxide, titanium nitride, titanium silicide, titanium silicate, silicon oxide, silicon nitride, silicon oxynitride, silicon carbide, or any combination thereof.

The protective coating provides protection against corrosion and oxidation when the aerospace component is exposed to air, oxygen, sulfur and/or sulfur compounds, acids, bases, salts (e.g., Na, K, Mg, Li, or Ca salts), or any combination thereof. The protective coating also provides protection against coke deposition.

The protective coating can have a thickness of about 1 nm, about 2 nm, about 3 nm, about 5 nm, about 8 nm, about 10 nm, about 12 nm, about 15 nm, about 20 nm, about 30 nm, about 50 nm, about 60 nm, about 80 nm, about 100 nm, or about 120 nm to about 150 nm, about 180 nm, about 200 nm, about 250 nm, about 300 nm, about 350 nm, about 400 nm, about 500 nm, about 800 nm, about 1,000 nm, about 2,000 nm, about 3,000 nm, about 4,000 nm, about 5,000 nm, about 6,000 nm, about 7,000 nm, about 8,000 nm, about 9,000 nm, about 10,000 nm, or thicker. In some examples, the protective coating can have a thickness of less than 10 μm (less than 10,000 nm). For example, the protective coating can have a thickness of about 1 nm to less than 10,000 nm, about 1 nm to about 8,000 nm, about 1 nm to about 6,000 nm, about 1 nm to about 5,000 nm, about 1 nm to about 3,000 nm, about 1 nm to about 2,000 nm, about 1 nm to about 1,500 nm, about 1 nm to about 1,000 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 50 nm, about 20 nm to about 500 nm, about 20 nm to about 400 nm, about 20 nm to about 300 nm, about 20 nm to about 250 nm, about 20 nm to about 200 nm, about 20 nm to about 150 nm, about 20 nm to about 100 nm, about 20 nm to about 80 nm, about 20 nm to about 50 nm, about 30 nm to about 400 nm, about 30 nm to about 200 nm, about 50 nm to about 500 nm, about 50 nm to about 400 nm, about 50 nm to about 300 nm, about 50 nm to about 250 nm, about 50 nm to about 200 nm, about 50 nm to about 150 nm, about 50 nm to about 100 nm, about 80 nm to about 250 nm, about 80 nm to about 200 nm, about 80 nm to about 150 nm, about 80 nm to about 100 nm, about 50 nm to about 80 nm, about 100 nm to about 500 nm, about 100 nm to about 400 nm, about 100 nm to about 300 nm, about 100 nm to about 250 nm, about 100 nm to about 200 nm, or about 100 nm to about 150 nm.

In one or more embodiments, the protective coating can have a relatively high degree of uniformity. The protective coating can have a uniformity of less than 50%, less than 40%, or less than 30% of the thickness of the respective protective coating. The protective coating can have a uniformity from about 0%, about 0.5%, about 1%, about 2%, about 3%, about 5%, about 8%, or about 10% to about 12%, about 15%, about 18%, about 20%, about 22%, about 25%, about 28%, about 30%, about 35%, about 40%, about 45%, or less than 50% of the thickness. For example, the protective coating can have a uniformity from about 0% to about 50%, about 0% to about 40%, about 0% to about 30%, about 0% to less than 30%, about 0% to about 28%, about 0% to about 25%, about 0% to about 20%, about 0% to about 15%, about 0% to about 10%, about 0% to about 8%, about 0% to about 5%, about 0% to about 3%, about 0% to about 2%, about 0% to about 1%, about 1% to about 50%, about 1% to about 40%, about 1% to about 30%, about 1% to less than 30%, about 1% to about 28%, about 1% to about 25%, about 1% to about 20%, about 1% to about 15%, about 1% to about 10%, about 1% to about 8%, about 1% to about 5%, about 1% to about 3%, about 1% to about 2%, about 5% to about 50%, about 5% to about 40%, about 5% to about 30%, about 5% to less than 30%, about 5% to about 28%, about 5% to about 25%, about 5% to about 20%, about 5% to about 15%, about 5% to about 10%, about 5% to about 8%, about 10% to about 50%, about 10% to about 40%, about 10% to about 30%, about 10% to less than 30%, about 10% to about 28%, about 10% to about 25%, about 10% to about 20%, about 10% to about 15%, or about 10% to about 12% of the thickness.

In one or more embodiments, the protective coating includes an alternating nanolaminate of a first material and a second material different than the first material. The first material can be or include chromium oxide, aluminum oxide, aluminum nitride, or combinations thereof. The second material can be or include one or more of aluminum oxide, aluminum nitride, aluminum oxynitride, silicon oxide, silicon nitride, silicon carbide, yttrium oxide, yttrium nitride, yttrium silicon nitride, hafnium oxide, hafnium silicate, hafnium silicide, hafnium nitride, titanium oxide, titanium nitride, titanium silicide, titanium silicate, dopants thereof, alloys thereof, or any combination thereof. The resultant film can be used as a nanolaminate film stack or the film can be subjected to annealing where the high temperature coalesces the films into a single structure where the new crystalline assembly enhances the integrity and protective properties of this overlying film.

In some embodiments, the protective coating includes the nanolaminate film stack having the first deposited layer containing aluminum oxide (or other base material) and the second deposited layer containing hafnium oxide (or other doping material), or having the first deposited layer containing hafnium oxide (or other doping material) and the second deposited layer containing aluminum oxide (or other base material). In one or more examples, the protective coating contains a combination of aluminum oxide and hafnium oxide, a hafnium-doped aluminum oxide, hafnium aluminate, or any combination thereof. For example, the protective coating includes the nanolaminate film stack having the first deposited layer contains aluminum oxide and the second deposited layer contains hafnium oxide, or having the first deposited layer contains hafnium oxide and the second deposited layer contains aluminum oxide. In other examples, the protective coating includes the coalesced film or crystalline film formed from layers of aluminum oxide and hafnium oxide.

Embodiments of the present disclosure further relate to any one or more of the following examples 1-26:

1. A method for cleaning an aerospace component, comprising: positioning the aerospace component into a processing region of a processing chamber; introducing hydrogen gas (H₂) into the processing region; maintaining the processing region at a pressure of about 100 mTorr to about 5,000 mTorr; and heating the aerospace component at a temperature of about 500° C. to about 1,200° C. for about 0.5 hours to about 24 hours to produce a cleaned surface on the aerospace component.

2. A method for cleaning an aerospace component, comprising: exposing the aerospace component to hydrogen gas (H₂) while heating the aerospace component at a temperature of about 500° C. to about 1,200° C. for about 0.5 hours to about 24 hours to produce a cleaned surface on the aerospace component.

3. The method according to any one of example 1 or 2, wherein the cleaned surface of the aerospace component comprises nickel, nickel superalloy, stainless steel, cobalt, chromium, molybdenum, iron, titanium, alloys thereof, or any combination thereof.

4. The method according to any one of example 1 or 2, wherein the cleaned surface of the aerospace component comprises a protective coating disposed on a nickel superalloy.

5. The method according to any one of example 4, wherein the protective coating comprises one or more layers, and each layer comprises a material selected from an aluminide, aluminum oxide, aluminum nitride, aluminum oxynitride, chromium oxide, hafnium oxide, tantalum oxide, tantalum nitride, tantalum oxynitride, silicon oxide, silicon nitride, silicon oxynitride, alloys thereof, or combinations thereof.

6. The method according to any one of examples 1-5, wherein the processing region is maintained at a pressure of about 500 mTorr to about 2,000 mTorr.

7. The method according to any one of examples 1-6, wherein the aerospace component is heated at a temperature of about 700° C. to about 1,100° C. for 1 hour to about 18 hours.

8. The method according to any one of examples 1-7, wherein the hydrogen gas is introduced into the processing region at a flow rate of about 50 sccm to about 5,000 sccm.

9. The method according to any one of examples 1-8, wherein the processing chamber is a tube furnace or thermal annealing chamber.

10. The method according to any one of examples 1-9, wherein the aerospace component comprises a turbine blade, a turbine blade root, a turbine disk, a turbine vane, a support member, a frame, a rib, a fin, a pin fin, a fuel nozzle, a fuel line, a fuel valve, a combustor liner, a combustor shield, a heat exchanger, or an internal cooling channel.

11. The method according to any one of examples 1-10, wherein the cleaned surface of the aerospace component is an interior surface within a cavity of the aerospace component.

12. The method according to any one of examples 1-11, wherein the cavity has an aspect ratio of about 5 to about 1,000.

13. The method according to any one of examples 1-12, wherein oxidation or corrosion is removed from the aerospace component to produce the cleaned surface.

14. A method for cleaning an aerospace component, comprising: positioning the aerospace component into a processing region of a processing chamber; introducing ozone into the processing region; maintaining the processing region at a pressure of up to 1,000 Torr (e.g., about 500 Torr to about 1,000 Torr); and maintaining the aerospace component at a temperature of about 15° C. to about 500° C. for 0.25 hours to about 24 hours to produce a cleaned surface on the aerospace component.

15. A method for cleaning an aerospace component, comprising: exposing the aerospace component to ozone while maintaining the aerospace component at a temperature of about 15° C. to about 500° C. for 0.25 hours to about 24 hours to produce a cleaned surface on the aerospace component.

16. The method according to any one of examples 14 or 15, wherein the cleaned surface of the aerospace component comprises nickel, nickel superalloy, stainless steel, cobalt, chromium, molybdenum, iron, titanium, alloys thereof, or any combination thereof.

17. The method according to any one of examples 14 or 15, wherein the cleaned surface of the aerospace component comprises a protective coating disposed on a nickel superalloy.

18. The method according to any one of examples 14-17, wherein the protective coating comprises one or more layers, and each layer comprises a material selected from an aluminide, aluminum oxide, aluminum nitride, aluminum oxynitride, chromium oxide, hafnium oxide, tantalum oxide, tantalum nitride, tantalum oxynitride, silicon oxide, silicon nitride, silicon oxynitride, alloys thereof, or combinations thereof.

19. The method according to any one of examples 14-18, wherein the processing region is maintained at a pressure of about 700 Torr to about 800 Torr.

20. The method according to any one of examples 14-19, wherein the aerospace component is heated at a temperature of about 100° C. to about 450° C. for 1 hour to about 18 hours.

21. The method according to any one of examples 14-20, wherein the ozone is introduced into the processing region at a flow rate of about 50 sccm to about 5,000 sccm.

22. The method according to any one of examples 14-21, wherein the processing chamber is a process furnace or thermal annealing chamber.

23. The method according to any one of examples 14-22, wherein the aerospace component comprises a turbine blade, a turbine blade root, a turbine disk, a turbine vane, a support member, a frame, a rib, a fin, a pin fin, a fuel nozzle, a fuel line, a fuel valve, a combustor liner, a combustor shield, a heat exchanger, or an internal cooling channel.

24. The method according to any one of examples 14-23, wherein the cleaned surface of the aerospace component is an interior surface within a cavity of the aerospace component.

25. The method according to any one of examples 14-24, wherein the cavity has an aspect ratio of about 5 to about 1,000.

26. The method according to any one of examples 14-25, wherein oxidation or corrosion is removed from the aerospace component to produce the cleaned surface.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A method for cleaning an aerospace component, comprising:
positioning the aerospace component into a processing region of a processing chamber;
introducing hydrogen gas (H₂) into the processing region;
maintaining the processing region at a pressure of about 100 mTorr to about 5,000 mTorr; and
heating the aerospace component at a temperature of about 500° C. to about 1,200° C. for about 0.5 hours to about 24 hours to produce a cleaned surface on the aerospace component.

2. The method of claim 1, wherein the cleaned surface of the aerospace component comprises nickel, nickel superalloy, stainless steel, cobalt, chromium, molybdenum, iron, titanium, alloys thereof, or any combination thereof.

3. The method of claim 1, wherein the cleaned surface of the aerospace component comprises a protective coating disposed on a nickel superalloy.

4. The method of claim 3, wherein the protective coating comprises one or more layers, and each layer comprises a material selected from an aluminide, aluminum oxide, aluminum nitride, aluminum oxynitride, chromium oxide, hafnium oxide, tantalum oxide, tantalum nitride, tantalum oxynitride, silicon oxide, silicon nitride, silicon oxynitride, alloys thereof, or combinations thereof.

5. The method of claim 1, wherein the processing region is maintained at a pressure of about 500 mTorr to about 2,000 mTorr.

6. The method of claim 1, wherein the aerospace component is heated at a temperature of about 700° C. to about 1,100° C. for 1 hour to about 18 hours.

7. The method of claim 1, wherein the hydrogen gas is introduced into the processing region at a flow rate of about 50 sccm to about 5,000 sccm.

8. The method of claim 1, wherein the aerospace component comprises a turbine blade, a turbine blade root, a turbine disk, a turbine vane, a support member, a frame, a rib, a fin, a pin fin, a fuel nozzle, a fuel line, a fuel valve, a combustor liner, a combustor shield, a heat exchanger, or an internal cooling channel.

9. The method of claim 1, wherein the cleaned surface of the aerospace component is an interior surface within a cavity of the aerospace component, and wherein the cavity has an aspect ratio of about 5 to about 1,000.

10. The method of claim 1, wherein oxidation or corrosion is removed from the aerospace component to produce the cleaned surface.

11. A method for cleaning an aerospace component, comprising:
positioning the aerospace component into a processing region of a processing chamber;
introducing ozone into the processing region;
maintaining the processing region at a pressure of about 500 Torr to about 1,000 Torr; and
maintaining the aerospace component at a temperature of about 15° C. to about 500° C. for 0.25 hours to about 24 hours to produce a cleaned surface on the aerospace component.

12. The method of claim 11, wherein the cleaned surface of the aerospace component comprises nickel, nickel superalloy, stainless steel, cobalt, chromium, molybdenum, iron, titanium, alloys thereof, or any combination thereof.

13. The method of claim 11, wherein the cleaned surface of the aerospace component comprises a protective coating disposed on a nickel superalloy.

14. The method of claim 13, wherein the protective coating comprises one or more layers, and each layer comprises a material selected from an aluminide, aluminum oxide, aluminum nitride, aluminum oxynitride, chromium oxide, hafnium oxide, tantalum oxide, tantalum nitride, tantalum oxynitride, silicon oxide, silicon nitride, silicon oxynitride, alloys thereof, or combinations thereof.

15. The method of claim 11, wherein the processing region is maintained at a pressure of about 700 Torr to about 800 Torr, and wherein the aerospace component is heated at a temperature of about 100° C. to about 450° C. for 1 hour to about 18 hours.

16. The method of claim 11, wherein the ozone is introduced into the processing region at a flow rate of about 50 sccm to about 5,000 sccm.

17. The method of claim 11, wherein the aerospace component comprises a turbine blade, a turbine blade root, a turbine disk, a turbine vane, a support member, a frame, a rib, a fin, a pin fin, a fuel nozzle, a fuel line, a fuel valve, a combustor liner, a combustor shield, a heat exchanger, or an internal cooling channel.

18. The method of claim 11, wherein the cleaned surface of the aerospace component is an interior surface within a cavity of the aerospace component, and wherein the cavity has an aspect ratio of about 5 to about 1,000.

19. The method of claim 11, wherein oxidation or corrosion is removed from the aerospace component to produce the cleaned surface.

20. A method for cleaning an aerospace component, comprising:
positioning the aerospace component into a processing region of a processing chamber;
introducing hydrogen gas (H₂) into the processing region;
maintaining the processing region at a pressure of up to 5,000 mTorr; and
heating the aerospace component at a temperature of about 500° C. to about 1,200° C. for about 0.5 hours to about 24 hours to produce a cleaned surface on the aerospace component, wherein:
the cleaned surface of the aerospace component comprises a protective coating disposed on a nickel superalloy,
the cleaned surface of the aerospace component is an interior surface within a cavity of the aerospace component, and
the cavity has an aspect ratio of about 5 to about 1,000.
